(19) United States
(12) Patent Application Publication
(10) Pub. No.: US 2026/0264466 A1
(43) Pub. Date: Sep. 10, 2026

(54) PNEUMATIC SYSTEM AND COMPRESSED AIR SUPPLY SYSTEM WITH BYPASS LINE AND SWITCHING AND CONTROL ACTUATOR SYSTEM IN THE VENTING PATH AND METHOD

(71) Applicant: ZF CV Systems Europe BV, Brussels (BE)

(72) Inventor: Uwe Stabenow, Laatzen (DE)

(21) Appl. No.: 19/658,388

(22) Filed: Apr. 24, 2026

Related U.S. Application Data
(63) Continuation of application No. PCT/EP2024/084100, filed on Nov. 29, 2024.

(30) Foreign Application Priority Data
Dec. 5, 2023 (DE) 10 2023 134 011.5

(51) Int. Cl. B60G 17/015

(52) U.S. Cl. CPC B60G 17/0155; B60G 2400/204; B60G 2400/51222; B60G 2500/2044; B60G 2600/66

(57) ABSTRACT

A pneumatic system includes a compressor, a pneumatic system with at least one compressed air consumer and a compressed air supply system for supplying the pneumatic system, with a pneumatic main line between a compressed air port and a compressed air supply port with an air dryer and a venting path. A pneumatic assembly is arranged in the venting path and includes a bypass line with a bypass diameter and a switching and control actuator system. The bypass line from a line portion of the venting path with a venting diameter includes an actuator element arranged in the line portion for selectively opening or blocking the line portion. A compressed air supply system is for supplying a pneumatic system. A vehicle includes the pneumatic system. A method is for operating a pneumatic system.

### CROSS-REFERENCE TO RELATED APPLICATIONS

This application is a continuation of international patent application PCT/EP2024/084100, filed November 29, 2024, designating the United States and claiming priority of German patent application no. 10 2023 134 011.5, filed December 5, 2023, and the entire content of both applications is incorporated herein by reference.

### TECHNICAL FIELD

The disclosure relates to a pneumatic system for a vehicle, in particular a passenger car, including a compressor, in particular a compressor, for providing compressed air with a supply pressure, a pneumatic system, in particular an air suspension system, with at least one compressed air consumer, a reservoir connected via a storage line, and a compressed air supply system to supply the pneumatic system with compressed air under gallery pressure. The compressed air supply system includes a compressed air port to the compressor, a compressed air supply port to the pneumatic system, a pneumatic main line between the compressed air port and the compressed air supply port with an air dryer, and a venting path with a vent port to the surrounding area and a venting line leaving from the pneumatic main line to the vent port.

The disclosure also relates to a compressed air supply system for a corresponding pneumatic system, a vehicle with such a pneumatic system, and a method for operating such a pneumatic system.

### BACKGROUND

A compressed air supply system is used in vehicles of all kinds, in particular for supplying a pneumatic system with compressed air, such as an air suspension system of a vehicle. Together with a compressor and the pneumatic system, the compressed air supply system forms a pneumatic system. Air suspension systems may also include level control devices that can be used to adjust the distance between the vehicle axle and the vehicle body. An air suspension system of a pneumatic system mentioned at the outset includes, as compressed air consumer, a number of air suspension bellows pneumatically connected to a common line (gallery), which can lift the vehicle structure as the filling increases and lower it accordingly as the filling decreases. As the distance between the vehicle axle and the vehicle body or ground clearance increases, the suspension travel becomes longer and even larger ground bumps can be overcome without contact with the vehicle body. Preferably, such systems are increasingly used in off-road vehicles and sport utility vehicles (SUVs). In particular for SUVs, it is desirable to provide the vehicle with comparatively low ground clearance for high speeds on the road on the one hand, and comparatively high ground clearance for off-road use on the other. It is also desirable to implement a change in ground clearance as quickly as possible, which increases the requirements for speed, flexibility and reliability of a compressed air supply system. A rapid lowering of the SUV requires rapid venting of the pneumatic system and especially of the air suspension bellows of the air suspension system via the venting path to the surrounding area.

To ensure long-term operation of the compressed air supply system, a pneumatic main line of the compressed air supply system has an air dryer to dry the compressed air. This prevents moisture from accumulating in the pneumatic system. Moisture at comparatively low temperatures can lead to valve-damaging crystal formation and also to undesirable defects in the compressed air supply system and in the pneumatic system. An air dryer has a desiccant, usually drying granules, which are passed through by the compressed air in such a way that the drying granules can absorb moisture contained in the compressed air by adsorption. An air dryer can be configured as a regenerative air dryer if necessary. This can be done by passing compressed air through the drying granules from a reservoir or the air suspension bellows – usually in counter-current, but sometimes also in direct current relative to the filling direction. The compressed air used to regenerate the air dryer is then discharged to the surrounding area via the venting path. The pressure of the compressed air in the reservoir is considerably higher than the pressure of the compressed air flowing from the pneumatic system and in particular the air suspension bellows of the air suspension system. The pressure inside the reservoir is usually in the range of 12 bar to 18 bar and the pressure of the compressed air discharged from the pneumatic system and especially the air suspension bellows is usually in the range of 0 bar to 12 bar.

When venting compressed air under reservoir pressure from the air dryer volume or the pneumatic main line, there is therefore a considerable noise embodiment due to the high pressures in the range from 12 bar to 18 bar. These noises, especially in electrically powered vehicles, are not usually covered by engine noises and are therefore perceived as disturbing. There is therefore a need to reduce the noise generated during venting. At the same time, the venting of the pneumatic system, especially the air suspension bellows, must not be obstructed in order to achieve rapid lowering times. For example, the DE 39 19 438 A1 shows a pneumatic system with a compressed air supply system and a consumer, such as an air suspension system. The compressed air supply system has a regenerative air dryer arranged in a pneumatic main line. In addition, an expansion tank is provided which is used to absorb air from the discharging consumers and to release air to the air dryer in regeneration mode. If the compressed air flows in the counter-current from the consumer or the expansion tank toward the air dryer, it passes through a dryer reactor, which lowers the pressure by a correspondingly low flow-through nominal diameter in order to allow moisture to be released from the drying granules. However, this dryer choke increases the venting time required by compressed air to escape from the consumer. In the case of an air suspension system as a consumer, this leads, for example, to increased lowering times and thus to restrictions on driving dynamics.

### SUMMARY

It is an object of the disclosure to specify a pneumatic system, a compressed air supply system for a corresponding pneumatic system and a method for operating a pneumatic system, which reduce the venting noise when venting compressed air under reservoir pressure and at the same time prevent the venting of the pneumatic system, in particular the air suspension bellows, from being impaired, while ensuring effective dryer regeneration.

In a first aspect of the disclosure, the object relating to the pneumatic system is achieved by a pneumatic system for a vehicle having: a compressor configured to provide compressed air; a pneumatic arrangement having at least one compressed air consumer; a compressed air supply system for supplying the pneumatic arrangement, with a compressed air port connected to the compressor, a compressed air supply port connected to the pneumatic arrangement, a pneumatic main line between the compressed air port and the compressed air supply port with an air dryer, and a venting path having a vent port to a surrounding area and a venting line leaving from the pneumatic main line to the vent port; a reservoir connected via a storage line to the compressed air supply port; a pneumatic assembly arranged in the venting path; the pneumatic assembly including a switching and control actuator system and a bypass line with a bypass diameter, which branches off at a first connection point from a line portion of the venting path with a venting diameter and reconnects to the line portion at a second connection point; the bypass diameter being smaller than the venting diameter; and, the switching and control actuator system having an actuator element arranged between the first connection point and the second connection point for selectively opening or blocking the line portion

With respect to the pneumatic system, the disclosure proposes a pneumatic assembly arranged in the venting path, which includes a bypass line with a bypass diameter and a switching and control actuator, wherein the bypass line branches off from a line portion of the venting path with a venting diameter at a first connection point and reconnects to the line portion at a second connection point. The disclosure further proposes that the bypass diameter is smaller than the venting diameter of the line portion and the switching and control actuator system has an actuator element arranged between the first connection point and the second connection point. It is defined that the venting diameter and the smaller by-pass diameter are both effective diameters and not absolute line diameters compared to this smaller diameter. The bypass line therefore always enables flow-through, regardless of the switching and control status of the switching and control actuator system, but causes a slowdown of the compressed air flowing in the direction of the vent port due to the bypass diameter. This reduces the venting noise. Furthermore, the line portion of the venting path with the larger venting diameter and the actuator element arranged in this allows rapid venting, wherein the actuator element of the switching and control actuator system allows control of the venting via the line portion and thus the resulting venting noises. This fast venting allows an effective regeneration of the air dryer. By actuating the actuator element accordingly, in order to quickly vent the pneumatic system, in particular, the air suspension bellows, the line portion with the venting diameter can be opened pneumatically in respect of flow-through. Compressed air flows both through the bypass line and through the line portion in the direction of the vent port or in the direction of the surrounding area. If, on the other hand, a venting of the pneumatic system is not necessary, but merely the venting of compressed air under reservoir pressure, the switching and control actuator is preferably configured by corresponding actuation of the actuator element to block the line portion, so that the compressed air can flow exclusively via the bypass line to the vent port or into the surrounding area. Actuating the actuator element is understood in the present case to mean both active actuation and actuation by omitting the provision of a control command, for example a control current. Depending on the normal position of the actuator element, in which it remains, for example, in a de-energized or pressureless state, for the release of the line portion with the venting diameter pneumatically in respect of flow-through, either an active actuation of the actuator element by applying a control current or a control pressure is necessary or simply an actuation by omitting or interrupting the provision of a control current or a control pressure.

According to various embodiments, the actuator element for selectively blocking or opening the line portion is arranged depending on at least one control variable, which correlates to a pressure of the compressed air led to the vent port and/or to a vehicle speed. The actuator element thus opens or blocks the line portion depending on at least one control variable and thus releases it again depending on the control variable. The pressure of the compressed air led to the vent port indicates whether it is a low pressure of, for example, 0 to 12 bar, as it usually occurs within the air suspension bellows of an air suspension system, or whether it is a higher pressure, in particular from 12 to 18 bar, as it usually occurs in the reservoir. If the pressure range is particularly 0 to 12 bar and thus a bellows venting process, an effective regeneration of the air dryer can be carried out and the compressed air can be led over the larger venting line diameter. Thus, a differentiation can be made, which indicates the need for rapid venting and thus a release of the line portion. In addition, the inventors recognized that a high vehicle speed is accompanied by increased noise levels due to the driving noise. This already increased noise generation also allows an increased noise generation when venting the pneumatic system, without this being perceived as disturbing by the occupants or even perceived by them. Thus, via a control variable which correlates to the vehicle speed, in the case that a blocking of the line portion is canceled, it is possible to prevent a predefined vehicle speed from being exceeded, which leads to a noise embodiment covering the venting noises. In this case, it is not necessary to reduce the speed of the compressed air flowing in the direction of the vent port or the surrounding area by passing through the bypass line with the bypass diameter.

The compressed air is sufficiently slowed down by a bypass diameter selected accordingly. A maximum venting diameter in the corresponding range also allows a sufficiently high venting speed and thus corresponding venting times for the rapid lowering of the vehicle structure in air suspension systems.

According to various embodiments, the pneumatic main line in the venting direction upstream of the air dryer has a main line diameter and the bypass diameter is greater than the main line diameter, in particular by 5% to 15% greater than the main line diameter. This prevents back pressure in the air dryer. According to various embodiments, the main line diameter is in a range of 0.8mm to 3.6mm.

According to various embodiments, the bypass diameter and the venting diameter together are larger than the main line diameter. The sum of the bypass diameter and the venting diameter is therefore greater than the main line diameter. This effectively prevents choke losses.

According to various embodiments, in the pneumatic main line is a dryer reactor with an inlet-side choke diameter, wherein the bypass diameter is greater than the choke diameter. This prevents choke losses in the pneumatic main line with the line diameter.

According to various embodiments, the venting line has a line diameter that is larger than the bypass diameter. A line diameter of the bypass line, which is reduced compared to the venting line, slows the compressed air as it flows through the bypass line in the direction of the vent port. According to various embodiments, the line diameter is at least 1.5x, especially preferably at least 2 times the main line diameter. Further preferably, the sum of the bypass diameter and the vent line diameter corresponds to at least one main line diameter of the pneumatic main line. This ensures efficient regeneration of the air dryer.

According to various embodiments, the control variable is a control current and the actuator element is an electromagnetically actuatable switching valve. The switching valve is preferably a 2/2-way solenoid valve that is closed when de-energized. Solenoid valves are characterized by fast reaction times. An actuator element is provided by a 2/2-way solenoid valve that is closed when de-energized and that in a normal state, that is, a state in which it is closed when de-energized, blocks the line portion and only releases the line portion in the event of activation with the control current. An electrical control variable in the form of a control current and an electrical actuation of the actuator element enables a higher accuracy than a pneumatic control variable and a corresponding pneumatic actuation of the actuator element.

According to various embodiments, the pneumatic system further includes at least one pressure sensor for measuring a pressure in the pneumatic main line and/or the pneumatic system. The control current is provided by the pressure measured by the pressure sensor when a predefined threshold value is exceeded. Via such a pressure sensor, the pressure in the pneumatic main line can be reliably detected and it is possible to differentiate whether the air in the pneumatic main line and in particular in the air dryer is compressed air from the pneumatic system, in particular the air suspension bellows, or whether it is compressed air from the reservoir, so that the compressed air from the air suspension bellows is quickly vented. However, depending on a predefined pressure threshold value, for example of 12 bar, which customers perceive as acoustically disruptive, a demand-oriented actuation of the actuator element can also take place. The pressure sensor is preferably connected to the electromagnetically actuatable switching valve and is set up to provide a control current depending on the measured value. Alternatively or in addition, a or the pressure sensor is connected to a control unit, in particular an ECU, wherein the control unit is configured for providing the control current.

According to various embodiments, the electromagnetically actuatable switching valve is connectable to a or the control unit of the vehicle for control purposes and the control current is provided by the control unit when the vehicle speed exceeds a predefined threshold value. Such a control unit, in particular an ECU, permanently detects the vehicle speed. A control of the actuator element in the form of an electromagnetically actuatable switching valve depending on the vehicle speed thus enables reliable control and rapid venting via the line portion only in the event that a sufficiently high vehicle speed is present and thus venting noises are covered.

According to a further embodiment, the control variable is a control pressure and the actuator element is a pneumatically actuatable valve, wherein the pneumatic assembly includes a control pressure line, which is set up for supplying the control pressure in the venting direction upstream of the pneumatically actuatable valve from the pneumatic main line and/or the line portion to the pneumatically actuatable valve. By using a control pressure as a control variable, the pressure in the pneumatic main line or in the line portion directly leads to an actuation of the actuator element in the form of a pneumatically actuatable valve. The pneumatic system, and especially the pneumatic assembly, is thus simplified and pressure-dependent control takes place, so that the reliability of the pneumatic assembly is increased. According to various embodiments, the pneumatically actuatable valve is a mechanical valve, which can be actuated by an air volume flow as a control variable. A mechanical valve is especially more robust compared to solenoid valves. This particularly applies to operation in the event of frost, as icing affects operation less due to a higher opening energy.

Further preferred is the pneumatically actuated valve a switching valve, in particular a 2/2-way valve, which is configured to block the line portion when a control pressure is applied above a predefined threshold value. Such a predefined threshold value is coupled in particular to the pressure in the reservoir. In the event that a pressure in the line portion or in the pneumatic main line is at the level of the reservoir pressure, a correspondingly high control pressure - which exceeds the threshold value - is applied and the line portion is blocked by the pneumatically actuated switching valve. In the preferred configuration of the switching valve as a 2/2-way valve, this preferably has a spring which exerts a spring force in the direction of an open position of the 2/2-way valve, so that the line portion is released until the pressure applied by the control pressure to the 2/2-way valve and in particular to a piston arranged in it overcomes the spring force.

According to various embodiments, the pneumatically actuatable valve is a proportionality valve or the actuator element includes a further pneumatically actuatable valve, which is a proportionality valve. The proportionality valve is configured to reduce a flow cross-section of the venting diameter depending on the applied control pressure. Thus, the speed of the compressed air flowing through the line portion is reduced by the proportionality valve depending on the applied control pressure. Due to the higher control pressure, a high pressure in the pneumatic main line thus simultaneously leads to a greater reduction in the flow cross-section and thus a higher reduction in the speed of the compressed air flowing in the direction of the vent port or the surrounding area. At the same time, such a proportionality valve allows a more precise control of the velocity of the outflowing compressed air just enough to avoid unintended noise embodiment. At the same time, an unnecessary reduction in the flow rate of compressed air, for example, which is only slightly above the pressure in the pneumatic system, is avoided.

According to various embodiments, the pneumatic assembly includes a storage device arranged upstream of the actuator element in the line portion in the venting direction. Such a storage device, which temporarily stores the applied compressed air, allows smaller fluctuations in the provision of a control pressure as a control variable and thus a more precise control of the actuator element.

According to an embodiment, the line portion forms the venting line in sections. Thus, the line portion and thus also the bypass line is integrated in the venting line or in the area of the venting line, and the pneumatic system, in particular the venting path, is thus configured to be more compact.

According to another embodiment, the pneumatic assembly is arranged at the vent port. An arrangement of the pneumatic assembly at the vent port makes it easy to retrofit existing pneumatic systems via such a pneumatic assembly and its connection to the vent port.

According to a further embodiment, the venting path includes a silencer arranged on the vent port and the pneumatic assembly extends at least in sections through the silencer. This means that the pneumatic assembly can be supplemented together with the silencer in pneumatic systems as required. Compressed air escaping through the pneumatic assembly is thus released in the area of the silencer and is dampened by it, so that the noise generation is further reduced.

According to a further embodiment, the venting line is a combined suction and venting line and the line portion forms the combined suction and venting line in sections. The line diameters of the line portion and the bypass line are adapted to the suction requirements of the compressor, which draws air from the surrounding area via the combined suction and venting line. This makes the pneumatic system more compact overall.

The disclosure relates in a second aspect to a compressed air supply system for supplying a pneumatic system, in particular an air suspension system, with a compressed air port to the compressor, a compressed air supply port to the pneumatic system and a pneumatic main line between the compressed air port and the compressed air supply port with an air dryer and a venting path with a vent port to the surrounding area and a venting line leaving from the pneumatic main line to the vent port. The disclosure solves the above-mentioned object in the second aspect via a pneumatic assembly arranged in the venting path, which includes a bypass line with a bypass diameter and a switching and control actuator system, wherein the switching and control actuator system at a first connection point branches off from a line portion of the venting path with a venting diameter and at a second connection point reconnects to the line portion, and the switching and control actuator system has an actuator element arranged between the first connection point and the second connection point. By such a pneumatic assembly arranged in the venting path, the compressed air supply system according to the second aspect of the disclosure makes use of the advantages described at the outset with respect to the first aspect of the disclosure. Embodiments and advantages described with respect to the first aspect of the disclosure are thus also embodiments and advantages of the compressed air supply system according to the second aspect of the disclosure.

The disclosure relates in a third aspect to a vehicle, in particular a passenger car with a pneumatic system according to the first aspect of the disclosure. By such a pneumatic system, the vehicle according to the third aspect of the disclosure adopts the advantages described above with respect to the first aspect of the disclosure. Embodiments and advantages described with respect to the first aspect of the disclosure are thus also embodiments and advantages of the vehicle according to the third aspect of the disclosure.

The disclosure relates in a fourth aspect to a method for operating a pneumatic system, in particular a pneumatic system according to the first aspect of the disclosure. In the method according to the fourth aspect of the disclosure, the object mentioned above is achieved by including the steps:
guiding compressed air from a compressed air supply port to a compressed air supply system, wherein the compressed air supply system is a compressed air supply port to a compressor, the compressed air supply port and a pneumatic main line between the compressed air port and the compressed air supply port to an air dryer and also a venting path with a vent port to the surrounding area and a venting line leaving from the pneumatic main line to the vent port,
guiding compressed air from the pneumatic main line to the venting path with a pneumatic assembly including a bypass line with a bypass diameter and a switching and control actuator system, wherein the bypass line branches off at a first connection point from a line portion of the venting path with a venting diameter and reconnects to the line portion at a second connection point, wherein the bypass diameter is smaller than the venting diameter and the switching and control actuator system has an actuator element arranged between the first connection point and the second connection point,
selectively blocking the line portion by the actuator element,
guiding compressed air via the bypass line with the first line diameter,
releasing the line portion by the actuator element in the event that a control variable does not exceed a predefined threshold value, and
guiding compressed air via the line portion.

By guiding compressed air from the pneumatic main line to a venting path with a pneumatic assembly including a bypass line and a switching and control actuator in a venting path, wherein the line portion is selectively blocked or opened by an actuator element of the switching and control actuator, the method according to the fourth aspect of the disclosure adopts the advantages described above in relation to the first aspect of the disclosure. Embodiments and advantages described with respect to the first aspect of the disclosure are thus also embodiments and advantages of the method according to the fourth aspect of the disclosure.

### BRIEF DESCRIPTION OF DRAWINGS

The invention will now be described with reference to the drawings wherein:

FIG. 1 shows a pneumatic system according to the prior art in a combined (bellows) venting and regeneration operation;

FIG. 2 shows a prior art pneumatic system in a combined (pressure store) venting and regeneration operation;

FIG. 3 shows a pneumatic system schematically according to a first embodiment when venting a pneumatic system;

FIG. 4 shows the pneumatic system according to FIG. 3 for venting a reservoir;

FIG. 5 shows a compressed air supply system for a pneumatic system according to FIGS. 3 and 4 according to a first embodiment;

FIG. 6 shows a compressed air supply system for a pneumatic system according to FIGS. 3 and 4 according to a second embodiment;

FIG. 7 shows a compressed air supply system for a pneumatic system according to FIGS. 3 and 4 according to a third embodiment;

FIG. 8 shows a compressed air supply system for a pneumatic system according to a fourth embodiment;

FIG. 9 shows a compressed air supply system for a pneumatic system according to FIGS. 3 and 4 according to a fourth embodiment; and,

FIG. 10 shows a method for operating a pneumatic system according to FIGS. 3 and 4.

### DETAILED DESCRIPTION

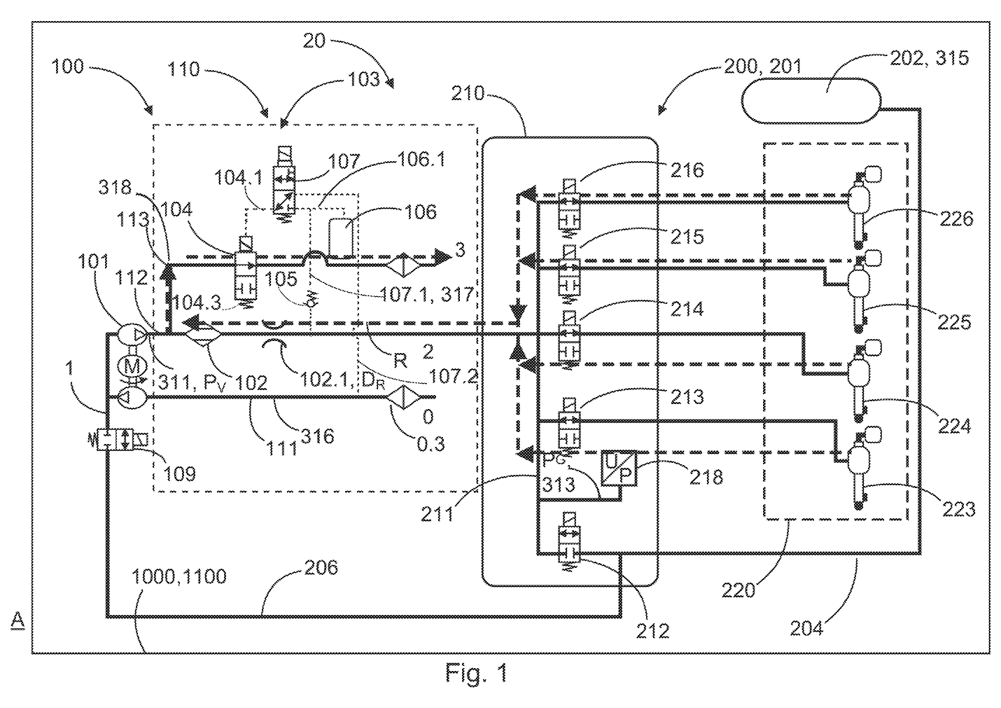

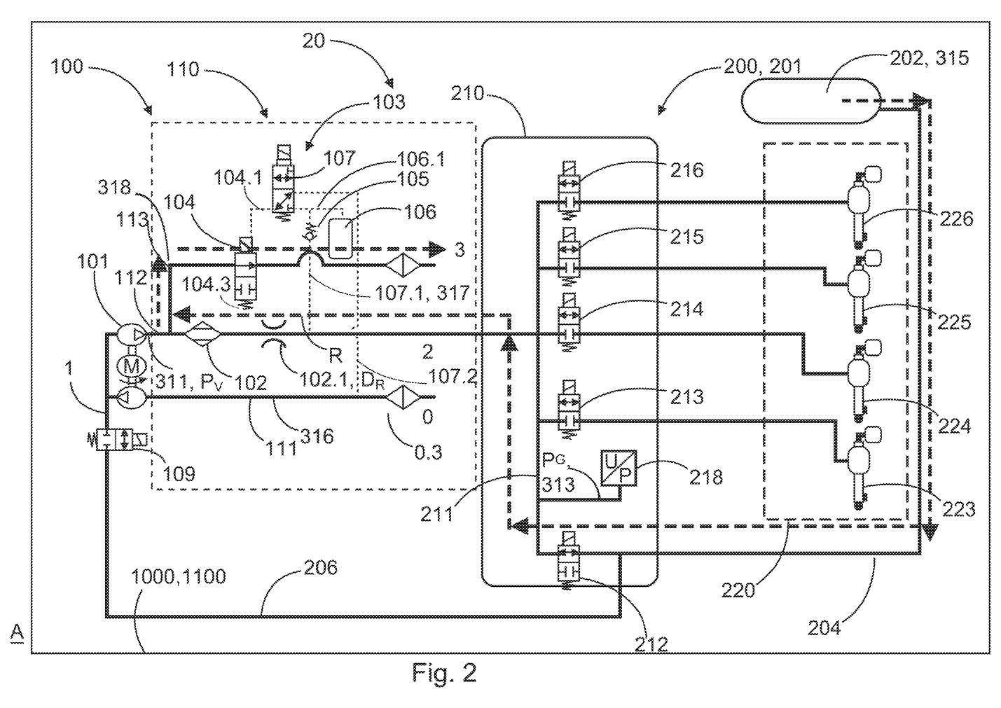

FIG. 1 and FIG. 2 show an example of a pneumatic system 20 with a compressed air supply system 100 and a pneumatic arrangement 200 in the form of an air suspension system 201. The shown pneumatic system 20 corresponds to the prior art.

The compressed air supply system 100 is used to operate the pneumatic arrangement 200. For this purpose, the compressed air supply system 100 has a compressed air port 1 and a compressed air supply port 2 to the pneumatic arrangement 200. The compressed air port 1 is connected to a suction port 0, a suction line 111, an air filter 0.3 upstream of the suction port 0 and a compressor 101 downstream of the suction port 0. The compressor 101 is set up to provide compressed air 311 with a supply pressure P_{V}. For example, the compressor 101 is a compressor driven by a motor M.

A first pneumatic connection is present with a pneumatic main line 112 formed between the compressed air port 1 and the compressed air supply port 2.

Further, the compressed air supply system 100 has a venting path 103, with a vent port 3 and a second pneumatic connection pneumatically connected to the pneumatic main line 112 and the vent port 3, namely the venting line 113. An air dryer 102 is also arranged in the pneumatic main line 112. In the present case, the venting line 113 between compressed air port 1 and air dryer 102 connects to the pneumatic main line 112. If necessary, the air is vented in a venting direction R via the pneumatic main line 112 and the venting line 113. A controllable venting valve 104 is provided in the venting line 113. The controllable venting valve 104 is present as an indirectly switched relay valve part of a solenoid valve arrangement 110 for indirectly switching a compressed air volume of the venting line 113 which can be filled from the pneumatic main line 112. The solenoid valve arrangement 110 includes a control valve 107 in the form of a 3/2-way solenoid valve. The control valve 107 can be actuated via electrical control signals in the form of a voltage and/or current signal. When actuated, the control valve 107 can be transferred from a position in which it is closed when de-energized (not shown) into a pneumatically open position shown in FIG. 1 and FIG. 2, in which a pressure derived from the pneumatic main line 112 via a pneumatic control line 107.1 is transmitted via a pilot line 104.1 for pneumatically controlling the controllable venting valve 104.

In the closed state (not shown), the control valve 107 disconnects the control line 107.1 and is pneumatically connected to the suction port 0 via a further pneumatic line 107.2 and can thus discharge compressed air 316 into the suction line 111.

In the pneumatic main line 112, a dryer choke 102.1 is arranged in the venting direction R upstream of the air dryer 102. The dryer choke 102.1 is configured to relax compressed air 313, 315 in counter-current only so far before the inflow into the air dryer 102 that a sufficient venting time during venting of the pneumatic arrangement 200 and thus achieved regeneration of the air dryer 102, as shown in FIG. 1, can be realized.

The control valve 107 is present assigned a first store 106, which is configured to receive compressed air 317 flowing through the control line 107.1 from the pneumatic main line 112. Compressed air 317 from the first store 106 can be fed to the vent port 3 via the control valve 107 and the venting valve 104, which is configured as a relay valve, and discharged to the surrounding area A. The first store 106 stores the compressed air 112 led from the pneumatic main line 317 to the control valve 107 via the control line 107.1 thus between, until the control valve 107 is electrically actuated so that the compressed air 317 from the first store 106 can reach the vent valve 104. The first store 106 is connected to the control valve 107 via a store supply line 106.1.

In this case, the air suspension system 201 has, as compressed air consumer 220, a number of four so-called air suspension bellows 223, 224, 225, 226, which are each assigned to a wheel of a vehicle 1000, not shown in greater detail, and form an air suspension of the vehicle 1000. The vehicle 1000 is in particular a passenger car 1100. Furthermore, the pneumatic system 20 has a reservoir 202 for storing quickly available compressed air for the air suspension bellows 223, 224, 225, 226. The air suspension bellows 223, 224, 225, 226 are each preceded by a solenoid valve 213, 214, 215, 216, which are each used as a level control valve for selectively opening and locking an air suspension formed with an air suspension 223, 224, 225, 226. The solenoid valves 213, 214, 215, 216 are configured as 2/2-way valves. A reservoir valve 212 is upstream of the reservoir 202 in a storage line 204. The reservoir valve 212 is a solenoid valve in the present case. The reservoir valve 212 is configured for selectively opening and blocking the storage line 204 to store excess compressed air 315 from the gallery 211 in the reservoir 202. The storage line 204 is connected to the compressor 101 via a filling line 206. In the filling line 206, a fast-filling valve 109 is arranged, which is a 2/2-way solenoid valve in the present case. For fast filling of the reservoir 202, the fast-filling valve 109 is configured for opening the filling line 206 pneumatically in respect of flow-through. Thus, the reservoir 202 can be filled independently of the pressure guide through the pneumatic main line 112.

The solenoid valves 213, 214, 215, 216, 94 and the reservoir valve 212 are connected to a common collecting line, a pneumatic line forming a gallery 211. The gallery 211 is pneumatically connected to the compressed air supply system 100 via the compressed air supply port 2. In the present case, the solenoid valves 213, 214, 215, 216 and the reservoir valve 212 are arranged in a valve block 210 with five valves. The solenoid valves 213, 214, 215, 216 and the reservoir valve 212 are shown in FIG. 1 in a de-energized state - wherein the solenoid valves 213, 214, 215, 216 and the reservoir valve 212 are formed as solenoid valves that are closed when de-energized. Other modified embodiments, not shown here, can realize a different arrangement of the solenoid valves 213, 214, 215, 216 and the reservoir valve 212 - there can also be used fewer or more solenoid valves in the frame of the valve block 210.

According to various embodiments, the pneumatic system has at least one pressure sensor 218 for measuring a gallery pressure P_{G} of compressed air 313 in the gallery 211 of the pneumatic arrangement 200.

In FIG. 1, the pneumatic system 10 is shown in a combined (bellows) venting and regeneration mode for venting the air suspension bellows 223, 224, 225, 226 of the pneumatic arrangement 200 with simultaneous regeneration of the air dryer 102. In FIG. 2, the pneumatic system 10 is shown in a combined (reservoir) venting and regeneration mode for venting the reservoir 202 while simultaneously regenerating the air dryer 102. Venting of the reservoir 202 is usually only necessary in the event of thermal fluctuations and thus expanding compressed air in the reservoir 202. Furthermore, a venting of the reservoir 202 allows a more efficient regeneration of the air dryer due to the higher output pressure, so that the (reservoir) venting and regeneration operation shown in FIG. 2 is also advantageous in this case.

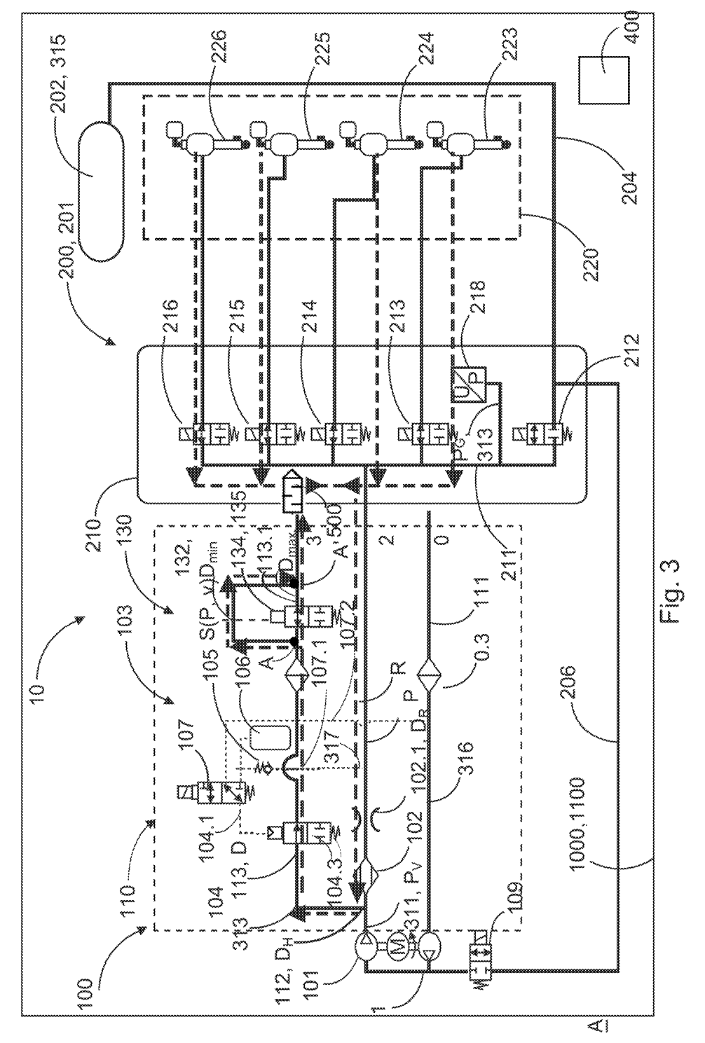

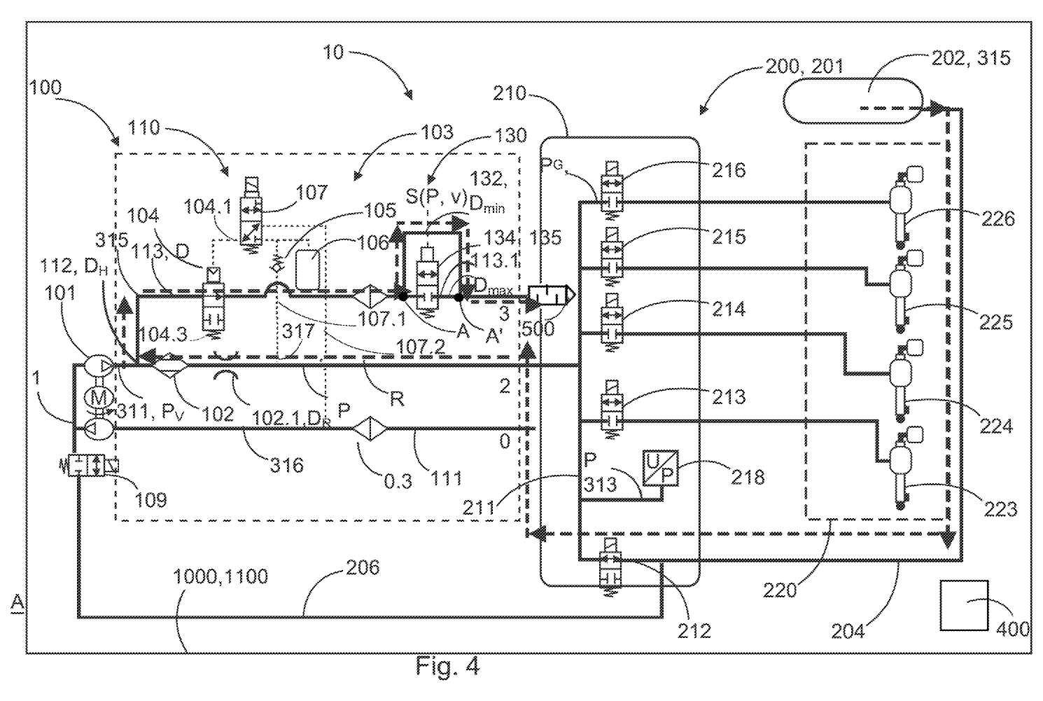

FIG. 3 and FIG. 4 show a pneumatic system 10 with a compressed air supply system 100 and a pneumatic arrangement 200 in the form of an air suspension system 201 according to an embodiment of the disclosure. The pneumatic system 10 according to FIGS. 3 and 4 differs from the pneumatic system 20 according to FIG. 1 and FIG. 2 by the formation of the venting path 103. Like or similar components have identical reference signs in FIG. 1 and FIG. 2 and also in FIGS. 3 and 4, and reference is made to the above description of the compressed air supply system 100 and the pneumatic arrangement 200 according to FIG. 1 and FIG. 2 in order to avoid repetition, and only differences in particular with regard to the formation of the venting section 103 will be discussed.

FIG. 3 shows the pneumatic system 10 in an operating state in which the pneumatic arrangement 200 and in particular the air suspension bellows 223, 224, 225, 226 of the air suspension system 201 are vented. In this state, the solenoid valves 213, 214, 215, 216, which are configured as 2/2-way valves that are closed when de-energized are energized and thus release a flow path for venting the air suspension bellows 223, 224, 225, 226 via the gallery 211 to the pneumatic main line 112. The reservoir valve 212, which is also configured as a 2/2-way solenoid valve that is closed when de-energized, does not release the store line 204 in the state shown, so that no compressed air 315 from the reservoir 202 can reach the pneumatic main line 112. The venting valve 104 is activated by the control valve 107 described above in an open position in which the venting valve 104 releases the venting path 113 of the venting path 103. The venting path 113 has a line diameter D.

FIG. 4 shows the pneumatic system 10 in an operating state in which the air dryer 102 is regenerated by compressed air 315 from the reservoir 202. The solenoid valves 213, 214, 215, 216 are in an unenergized state, so that they block the flow path between the air suspension bellows 223, 224, 225, 226 and the pneumatic main line 112. The reservoir valve 212, on the other hand, is shown in a powered state in which the storage line 204 is released pneumatically in respect of flow-through, so that compressed air 315 from the reservoir 202 via the storage line 204 can reach the pneumatic main line 112 and finally to the air dryer 102 and flows through it in the counter-current in the direction of the vent port 3. The control valve 107 actuates the venting valve 104 in the manner described above, so that the venting valve 104 releases the venting line 113 pneumatically in respect of flow-through.

The pneumatic system 10 according to FIG. 3 and FIG. 4 differs from the pneumatic system 20 shown in FIG. 1 and FIG. 2 according to the prior art by a pneumatic assembly 130 arranged in the venting path 103, which has a bypass line 132 which branches off from a line portion 113.1 of the venting path 103, in particular, the venting line 113, at a first connection point A and reconnects to a second connection point A'. Further, the pneumatic assembly 130 includes a switching and control actuator 134 having an actuator element 135 connected between the first connection point A and the second connection point A' for selectively opening or blocking the line portion 113.1.

The actuator element 135 is set up for selectively opening or blocking the line portion 113.1 depending on at least one control variable S. The control variable S correlates to a pressure P, the compressed air 313, 315 led to the vent port 3, or to a vehicle speed v.

The pneumatic main line 112 has a main line diameter D_{H}. The line portion 113.1 further has a venting diameter Dₘₐₓ and the bypass line 132 has a bypass diameter Dₘᵢₙ. The bypass diameter Dₘᵢₙ is smaller than the venting diameter Dₘₐₓ.

The dryer choke 102.1 has an inlet -side choke diameter D_{R}, wherein the bypass diameter Dₘᵢₙ is greater than the choke diameter D_{H}.

The actuator element 135 can preferably be configured as a switching valve. For venting the pneumatic arrangement 200, as shown in FIG. 3, the switching and control actuator 134 with the actuator element 135 is configured to release the line portion 113.1 with the venting diameter Dₘₐₓ. Compressed air 313 from the pneumatic arrangement 200 thus flows both via the line portion 113.1 with the venting diameter Dₘₐₓ and via the bypass line 132 with the bypass diameter Dₘᵢₙ when the actuator element 135 is switched, as shown. Thus, a rapid venting of the pneumatic arrangement 200 can be realized, wherein the comparatively low gallery pressure P_{G} of the compressed air 313 within the pneumatic arrangement 200 leads to an acceptable noise embodiment. This can also be ensured in particular when guiding the line portion 113.1 with the venting diameter Dₘₐₓ. This ensures effective regeneration of the air dryer 102.

If, on the other hand, the air dryer 102 is regenerated by compressed air 315 from the reservoir 202, as shown in FIG. 4, the switching and control actuator system 134 with the actuator element 135 is set up to block the line portion 113.1 by corresponding switching of the actuator element 135 configured as a switching valve. In this case, the actuator element 135 is switched by omitting the provision of a control variable, that is, by "not switching” so to speak. In this case, compressed air 315 from the reservoir 202 is fed exclusively via the bypass line 132 with the bypass diameter Dₘᵢₙ to the vent port 3. By guiding the compressed air 315 via the bypass line 132 with the bypass diameter Dₘᵢₙ, it is slowed down so that the noise generated during venting is reduced.

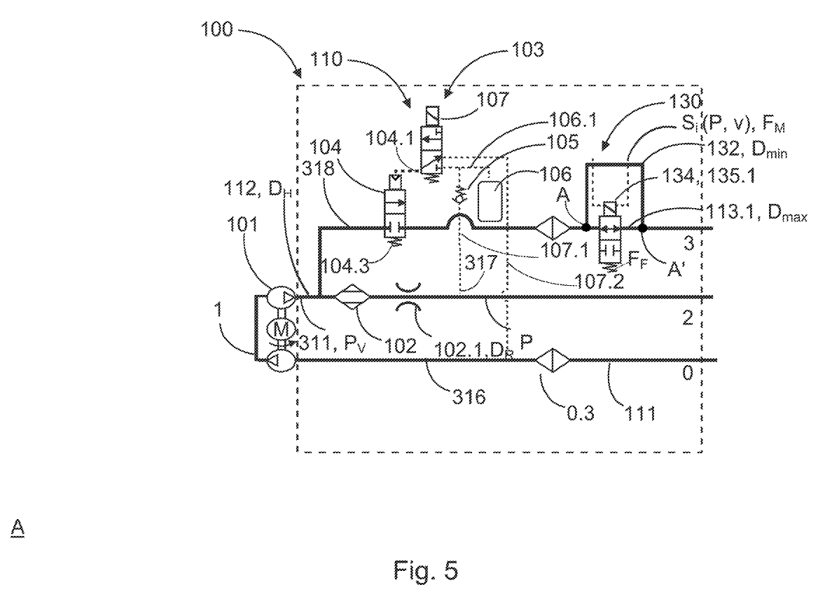

According to various embodiments, the switching valve 135 can be connected to a control unit 400 of the vehicle 1000 for control purposes, wherein the control variable S, for example, is a control current S_{I} (see FIG. 5) and is provided by the control unit 400 when a predefined threshold value Smax is exceeded by the vehicle speed v (see FIG. 5). According to various embodiments, the switching and control actuator system 134 may also include a control unit or a control portion (not shown), wherein the control portion is set up for providing the control variable S.

Thus, the air pressure 315 is guided via the bypass line 132 with the bypass diameter Dₘᵢₙ to the vent port 3 only in cases where this is necessary for acoustic reasons. This avoids a reduction in the nominal flow-through diameter that is not necessary from an acoustic point of view and thus a reduction in the efficiency when regenerating the air dryer 102.

A silencer 500 is connected to the vent port 3 and is also part of the venting path 103. According to various embodiments, the pneumatic assembly 130 can also be arranged in the silencer 500 as a total unit.

According to various embodiments, the pressure sensor 218 for measuring the pressure P of the compressed air 313 in the gallery 211 is connected to the control unit 400, wherein the control variable is provided depending on the measured pressure P. Alternatively or in addition, the pressure sensor 218 or an additional pressure sensor may also be arranged in the pneumatic main line 112 and may be connected to the control unit 400 for control purposes, the control variable being provided depending on the measured pressure P in the pneumatic main line 112.

FIGS. 5 to 9 show the compressed air supply system 100 with different embodiments of the pneumatic assembly 130.

In FIG. 5, the pneumatic assembly 130 has an actuator element 135 formed as an electrically actuable switching valve 135.1. The switching valve 135.1 is preferably configured as a 2/2-way valve 135.1. The actuator element 135 is set up for selectively opening or blocking the line portion 113.1 depending on at least one control variable S. The control variable S correlates to a pressure P, the compressed air 313, 315 led to the vent port 3, or to a vehicle speed v.

According to the embodiment shown in FIG. 5, the actuator element 135 is an electromagnetically actuatable switching valve 135.1, which is preferably configured as a 2/2-way solenoid valve that is closed when de-energized. The control variable S is a control current S_{I} which correlates to the pressure P of the compressed air to the compressed air port 3 or to a speed v of the vehicle 1000. When the control current S_{I} is present, as shown in FIG. 5, a magnetic force F_{M} is applied, which overcomes a spring force F_{F} acting on the magnetically actuable switching valve 135.1.

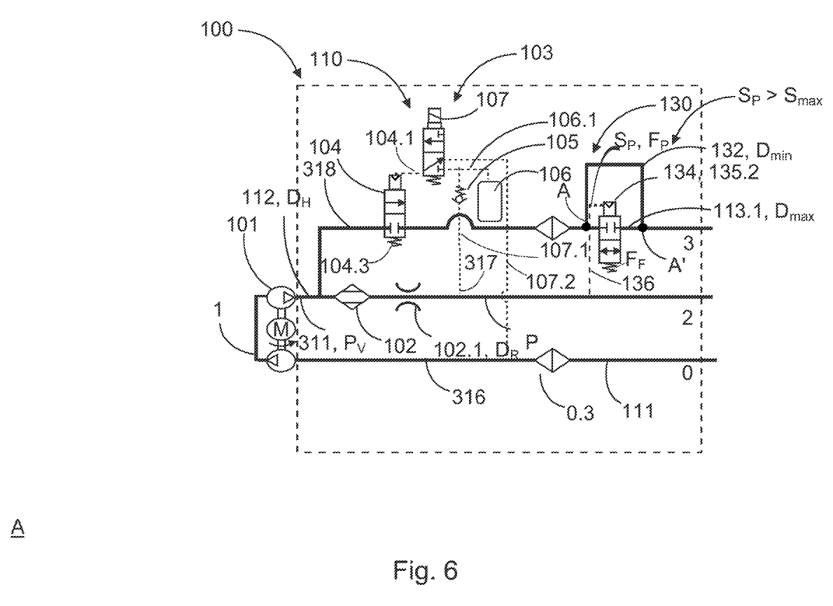

According to the embodiment shown in FIG. 6, the actuator element 135 is a pneumatically actuatable switching valve 135.2, which is preferably configured as a 2/2-way valve that is open in the pressureless state, with a control pressure line 136 of the switching and pneumatic assembly 134, which connects to the pneumatic main line 112. The control variable S is a control pressure S_{P}, which is provided via the control pressure line 136 depending on the pressure P in the pneumatic main line 112. In FIG. 6, the control pressure S_{P} is greater than a predefined threshold value Sₘₐₓ, wherein the pneumatically actuatable switching valve 135.2 is set up for this case to block the line portion 113.1 pneumatically in respect of flow-through. The actuator element 135 is thus shown in an actuated state. In this case, a pressure force F_{P} applied by the control pressure S_{P} overcomes a spring force F_{F} acting on the switching valve 135.2.

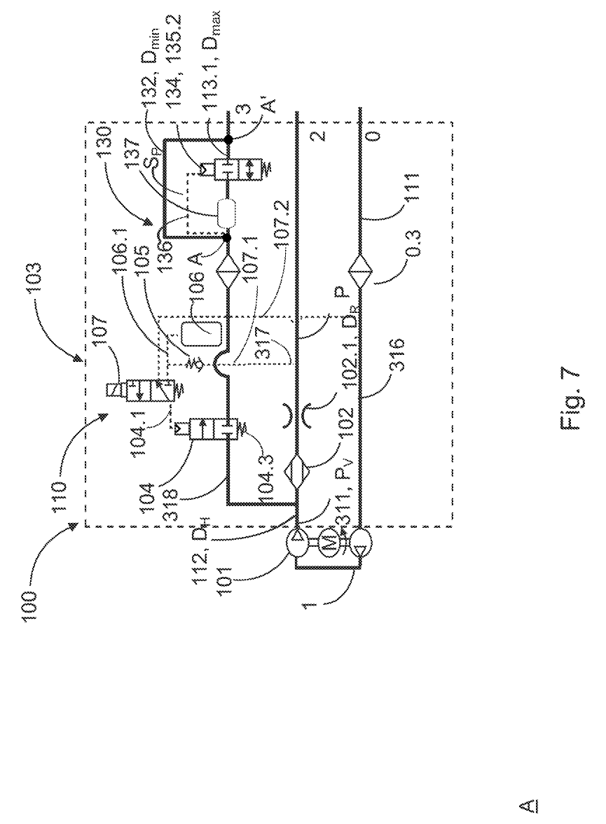

The embodiment shown in FIG. 7 differs from the above embodiment shown in FIG. 6 only in that the pneumatically actuated switching valve 135.2 connects with the control line 136 to the line portion 113.1 and the control pressure S_{P} is determined by the pressure in the line portion 113.1. In the line portion 113.1, a second store 137 of the pneumatic assembly 130 is also set up for intermediate storage of the compressed air 313, 315 located in the line portion 113.1.

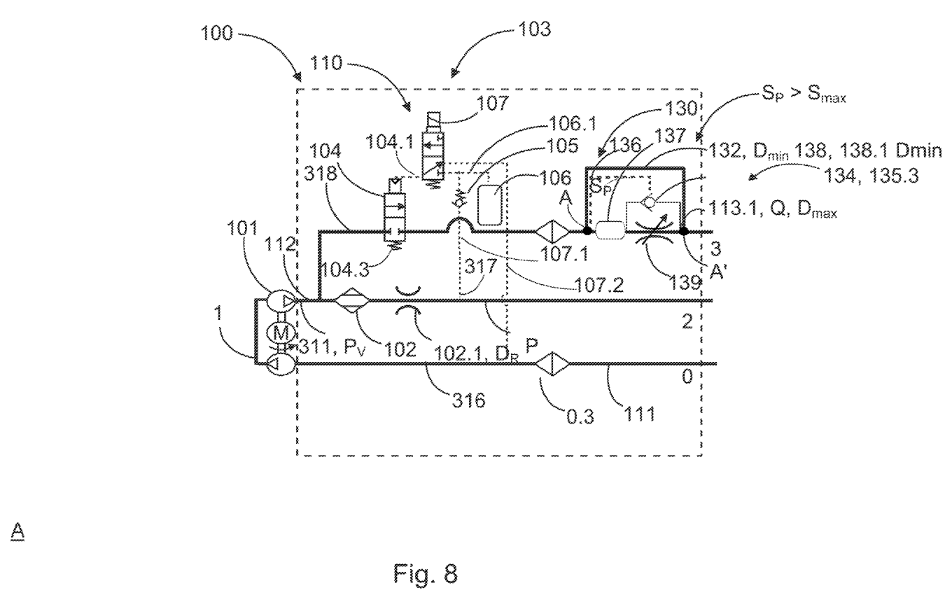

According to the embodiment shown in FIG. 8, the switching and control actuator 134 includes an actuator element 135 formed as a pneumatically actuatable proportionality valve 135.3. The control variable S is also a control pressure S_{P}, which is provided via a control pressure line 136, which connects to the line portion 113.1. In the line portion 113.1 there is also arranged a second store 137, which according to the second store 137 shown in FIG. 7, temporarily stores the compressed air in the line portion 113.1.

The proportionality valve 135.3 includes a bypass branch 138.1 with a check valve 138 and a controllable choke 139 in the line portion 113.1. The check valve 138 can only enable flow-through in the direction of the vent port 3. The controllable choke 139 is configured to reduce its flow cross-section - and thus a flow cross-section Q of the line portion 113.1 - depending on the control pressure S_{P} and to completely block it when a threshold value Sₘₐₓ is exceeded. The check valve 138 is configured to open depending on the pressure in the event that the control pressure S_{P} exceeds the threshold value Sₘₐₓ. The bypass branch 138.1 with the check valve 138 also has the bypass diameter Dₘᵢₙ.

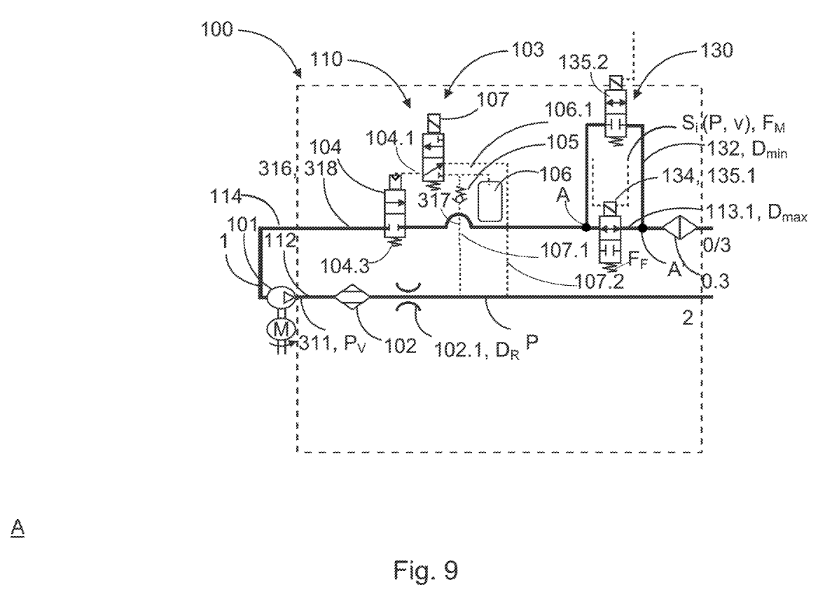

The embodiment of the compressed air supply system 100 shown in FIG. 9 differs from the above embodiment shown in FIG. 5 only in that the venting line and the suction line are preferably formed as a combined suction and venting line 114 to a combined suction and vent port 0/3 and the venting path 103. The bypass diameter Dₘᵢₙ is adapted to the requirements of compressor 101, so that a sufficient compressed air flow can be drawn in.

Furthermore, the electrically actuatable switching valve 135.1 is preferably a first electrically actuatable switching valve 135.1 and the pneumatic assembly 130 has a second electrically actuatable switching valve 135.2, which is preferably configured as a 2/2-way valve 135.1. The second electrically actuatable switching valve 135.2 is set up for selectively opening or blocking the bypass line 132 depending on at least the control variable S. This makes the control of the pneumatic assembly 130 more precise and increases system safety. It should be understood that such a second electrically switching valve 135.2 can also be provided independently of the formation of the venting line and the suction line as a combined suction and venting line 114.

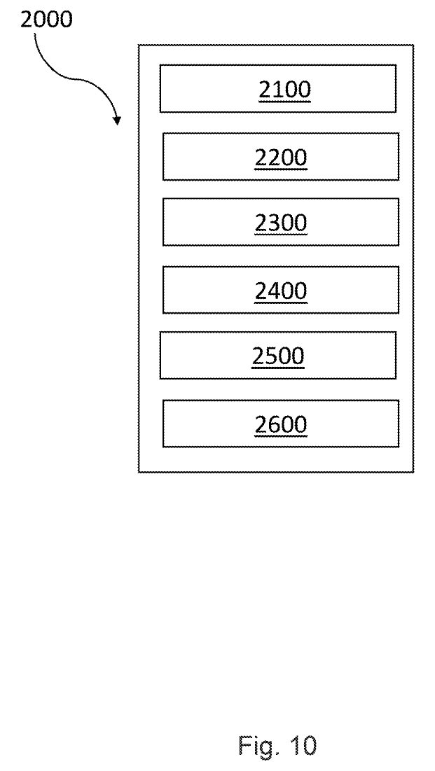

FIG. 10 shows a method 2000 for operating a pneumatic system 10, as shown, for example, in FIGS. 3 and 4. The method 2000 includes guiding compressed air from a pneumatic arrangement 200 to a compressed air supply system 100 in step 2100, wherein the compressed air supply system 100 according to the embodiment shown in FIG. 3 and 4 is formed. Furthermore, the method 2000 includes guiding compressed air 313, 315 from the pneumatic main line 112 to the venting path 103 with a pneumatic assembly 130 shown in FIGS. 3 to 9 in step 2200. Especially since the pneumatic assembly 130 is formed as described above, in a further step 2300 the line portion 113.1 is selectively blocked or opened by the actuator element 135 of the switching and control actuator system 134 depending on the control variable S, in the case that the control variable Sₘₐₓ exceeds a predefined threshold value, for example. In this case, compressed air 315 is fed in a further step 2400 via the bypass line 132 with the bypass diameter Dₘᵢₙ. Alternatively, the line portion 113.1 is released in a further step 2500 by the actuator element 135, in the event that the control variable S does not exceed the predefined threshold value Sₘₐₓ and in addition, in a further step 2600, compressed air 313 is also guided via the line portion 113.1.

In other words, the threshold value Sₘₐₓ is determined depending on acoustic effects, that is, either depending on a speed and the associated acoustic effects, which cover any venting noises, or on the pressure of the compressed air to be vented, which determines the noise level during venting.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

0 Suction port

0/3 Combined suction and vent port

1 Compressed air port

2 Compressed air supply port

3 Vent port

0.3 Air filter

10 Pneumatic system

100 Compressed air supply plant

101 Compressor

102 Air dryer

102.1 Dryer choke

103 Venting path

104 Venting valve

104.1 Pilot line

105 Check valve

106 (First) store

106.1 Storage supply line

107 Control valve

107.1 Control line

107.2 Pneumatic line

109 Fast-filling valve

110 Solenoid valve arrangement

111 Suction line

112 Pneumatic main line

113 Vent line

113.1 Line portion

114 Combined suction and vent line

130 Pneumatic assembly

132 Bypass line

134 Switching and control actuator system

135 Actuator element

135.1 First switching valve

135.2 Second switching valve

136 Control pressure line

137 Second store

138 Check valve

138.1 Bypass branch

139 Controllable choke

200 Pneumatic arrangement

202 Reservoir

204 Storage line

206 Filling line

210 Valve block

211 Gallery

212 Reservoir valve

213, 214, 215, 216 Solenoid valves

218 Pressure sensor

220 Compressed air consumer

223, 224, 225, 226 air suspension bellows

311 Compressed air from the compressor

313 Compressed air from the gallery

315 Compressed air from the reservoir

316 Compressed air in the suction line

317 Compressed air in the control pressure line

400 Control unit

500 Silencer

1000 Vehicle

1110 Passenger car

2000 Method

2100 Provide compressed air at a supply pressure

2200 Fill the reservoir

2300 Dry the compressed air through an air dryer

2400 Supply the pneumatic system with compressed air

2500 Vent the pneumatic system

2600 Regenerate the air dryer

A Surrounding area

F_{F} Spring force

F_{P} Compressive force

M Motor

P Pressure

P_{G} Gallery pressure

S Control variable

S_{P} Control pressure

S_{I} Control current

v Speed

Q Flow cross-section

R Venting direction

Dₘᵢₙ Bypass diameter

D_{Max} Venting diameter

D Line diameter

D_{H} Main line diameter

D_{R} Choke diameter

1. A pneumatic system for a vehicle, the pneumatic system comprising:
a compressor configured to provide compressed air;
a pneumatic arrangement having at least one compressed air consumer;
a compressed air supply system for supplying said pneumatic arrangement, with a compressed air port connected to the compressor, a compressed air supply port connected to said pneumatic arrangement, a pneumatic main line between said compressed air port and said compressed air supply port with an air dryer, and a venting path having a vent port to a surrounding area and a venting line leaving from said pneumatic main line to said vent port;
a reservoir connected via a storage line to said compressed air supply port;
a pneumatic assembly arranged in said venting path;
said pneumatic assembly including a switching and control actuator system and a bypass line with a bypass diameter, which branches off at a first connection point from a line portion of said venting path with a venting diameter and reconnects to said line portion at a second connection point;
said bypass diameter being smaller than said venting diameter; and,
said switching and control actuator system having an actuator element arranged between said first connection point and said second connection point for selectively opening or blocking said line portion.

2. The pneumatic system of claim 1, wherein said actuator element for selectively opening or blocking said line portion is configured in dependence upon at least one control variable that correlates to at least one of:
a pressure of the compressed air guided to said vent port; and,
a vehicle speed.

3. The pneumatic system of claim 2, wherein at least one of:
said pneumatic main line has a main line diameter in a venting direction upstream of said air dryer and said bypass diameter is greater than said main line diameter;
a dryer choke is disposed in said pneumatic main line, said dryer choke having an inlet-side choke diameter and said bypass diameter being greater than said choke diameter; and,
said bypass diameter and said vent diameter together are larger than said main line diameter.

4. The pneumatic system of claim 1, wherein said venting line has a line diameter which is greater than said bypass diameter.

5. The pneumatic system of claim 2, wherein said at least one control variable is a control current and said actuator element is an electromagnetically actuatable switching valve.

6. The pneumatic system of claim 5 further comprising:
at least one pressure sensor for measuring a pressure in at least one of said pneumatic main line and said pneumatic arrangement;
wherein at least one of:
said control current is provided by the measured pressure when a predefined threshold value is undershot; and,
said electromagnetically actuatable switching valve is connectable to a control unit of the vehicle for control purposes and said control current is provided by the control unit when a predefined threshold value is exceeded by the vehicle speed.

7. The pneumatic system of claim 2, wherein said at least one control variable is a control pressure and said actuator element is a pneumatically actuatable valve; and, said pneumatic assembly includes a control pressure line configured to supply the control pressure in a venting direction upstream of said pneumatically actuatable valve from at least one of said pneumatic main line and said line portion to said pneumatically actuatable valve.

8. The pneumatic system of claim 7, wherein said pneumatically actuatable valve includes a switching valve configured to block said line portion when a control pressure is applied above a predefined threshold value.

9. The pneumatic system of claim 7, wherein said pneumatically actuatable valve is a proportional valve configured to reduce a flow cross-section of said line portion depending on an applied control pressure.

10. The pneumatic system of claim 7, wherein said pneumatic assembly has a store arranged in the venting direction upstream of said actuator element in said line portion.

11. The pneumatic system of claim 1, wherein said line portion forms said venting line in sections.

12. The pneumatic system of claim 1, wherein said pneumatic assembly is connected to said vent port.

13. The pneumatic system of claim 1, wherein the vehicle is a passenger car.

14. The pneumatic system of claim 1, wherein the pneumatic arrangement is an air suspension system.

15. The pneumatic system of claim 2, wherein said pneumatic main line has a main line diameter in a venting direction upstream of said air dryer and said bypass diameter is 5% to 15% larger than said main line diameter.

16. The pneumatic system of claim 1, wherein a line diameter of said venting line is at least one of at least 1.5 times and at least 2 times the main line diameter.

17. A compressed air supply system for supplying a pneumatic system, the compressed air supply system comprising:
a compressed air port for connecting to a compressor;
a compressed air supply port for connecting to the pneumatic system;
a pneumatic main line between said compressed air port and said compressed air supply port;
an air dryer;
a venting path with a vent port to a surrounding area;
a venting line leading from said pneumatic main line to said vent port;
a pneumatic assembly arranged in said venting path;
said pneumatic assembly including a switching and control actuator system and a bypass line with a bypass diameter;
said bypass line branching off at a first connection point from a line portion of said venting path with a venting diameter and reconnecting to said line portion at a second connection point;
said bypass diameter being smaller than said venting diameter; and,
said switching and control actuator system having an actuator element arranged between said first connection point and said second connection point for selectively opening or blocking said line portion.

18. The compressed air supply system of claim 17, wherein said pneumatic system is an air suspension system.

19. A vehicle comprising the pneumatic system of claim 1.

20. A vehicle comprising the compressed air supply system of claim 17.

21. A method for operating a pneumatic system, the method comprising:
guiding compressed air from a compressed air supply port to a compressed air supply system, wherein the compressed air supply system includes the compressed air supply port connected to a compressor, the compressed air supply port and a pneumatic main line between a compressed air port and the compressed air supply port being connected to an air dryer and also a venting path with a vent port to a surrounding area, and a venting line leading from the pneumatic main line to the vent port;
guiding the compressed air from the pneumatic main line to the venting path with a pneumatic assembly, wherein the pneumatic assembly includes a bypass line with a bypass diameter and a switching and control actuator system, wherein the bypass line branches off at a first connection point from a line portion of the venting path with a venting diameter and at a second connection point reconnects to the line portion, and the switching and control actuator system has an actuator element arranged between the first connection point and the second connection point;
selectively blocking the line portion by the actuator element;
guiding the compressed air via the bypass line with the bypass diameter;
releasing the line portion by the actuator element in the event that a control variable does not exceed a predefined threshold value; and,
guiding the compressed air via the line portion.
